(19) United States
(12) Patent Application Publication
(10) Pub. No.: US 2022/0391794 A1
(43) Pub. Date: Dec. 8, 2022

(54) RISK IDENTIFICATION AND VISUALIZATION SYSTEM AND METHOD

(71) Applicant: INDUS INTELLIRISK AND INTELLISENSE SERVICES PRIVATE LIMITED, New Delhi (IN)

(72) Inventors: Gurpawan SINGH, New Delhi (IN); Sagarika CHAKRABORTY, New Delhi (IN)

(21) Appl. No.: 17/755,920

(22) PCT Filed: Nov. 11, 2020
(86) PCT No.: PCT/IN2020/050950

§ 371 Date: May 11, 2022

(30) Foreign Application Priority Data
Nov. 12, 2019 (IN) 201911045954

(51) Int. Cl. G06Q 10/06

(52) U.S. Cl. CPC G06Q 10/0635

(57) ABSTRACT

Disclosed herein is a system for dynamically identifying risks related to a facility. The system comprises a computing unit having a processor and memory configured to execute one or more programming instructions embodied thereon. The computing unit includes a data receiving component adapted to receive one or more datasets from one or more data sources. The received datasets pertains to the risks associated to said facility and includes in-facility data source as well as out-facility data source. The computing unit further includes a risk scoring module adapted to assess the risk associated to said facility and process the programming instructions embodied onto the memory to determine threats and/or risks scores related to the facility using the received data sets. A visualization generation component dynamically generates an interactive visualization of the risks and/or threats on to an output screen.

### TECHNICAL FIELD

The present subject matter generally relates to a risk identification system and method. In particular, the present subject matter relates to a system and method for dynamically visualizing the risks identified within a facility.

### BACKGROUND

Every industrial/infrastructure facility has sensitive assets which are vulnerable to risks. For example, some critical assets for utilities may include devices running in substations, devices running in nuclear plants and so on. Some assets may be physical, such as the above-mentioned devices, and some may be information technology (IT) systems. There are chances that such systems face various possible security, safety, facility management risk across various internal and external environments across the facility which needs to be timely and carefully managed. Threats (human-caused) and hazards (naturally occurring threats) are potential risks which might be harmful to the safety and security of people, property, processes (e.g. processes of public entities, private industry, etc.) and special events. Such potential risks are usually easier to detect in the context of a particular facility but not so readily detectable when considered in terms of geographical areas and locations.

Managing risk generally involves the process of determining the risk and taking steps to decrease the risk by decreasing the probability or vulnerability, or both. Managing risk is an important task faced by people in different situations. For example, insurance companies and financial planners manage risk to capital when deciding when to insure and what stocks on bonds to include in a portfolio. Homeowners manage risk when deciding whether to purchase a burglar alarm system. All these risks are particularly impacted by various factors internal to the facility as well as other factors external to the facility.

Currently there are several threat detecting, identification system which often force the management to buy very expensive command center applications and software suites that is a steep financial drain, difficult and expensive to maintain and operate; and many a times, does not meet requirements on ground. Further, such risk identification systems merely consider only a fraction of factors, particularly, only the internal factors for assessment of such risks. Traditional risk detection tools and applications have focused on just user access re-affirmation generally providing a one-size-fits-all solution which is not recommended at all. To truly determine and monitor the risks associated with a facility, it is essential to link all the physical as well as logical parameter and provide real-time impact to detect status of health, risks and threats associated thereto. There are some custom based applications that clients use which are built around their needs, and there are others which do not give clients full advantage as they are built around a fraction of available parameters available within the facility that could determine risks and threats due to factors present within the facility. Moreover, the majority of such customized tools are resource hungry and are difficult to configure/manage/upgrade due to the legacy nature of existing systems.

In order to accurately and timely determine any threats, the underlying components of associated threat parameters must be studied in detail and these threat parameters must be made available to a threat detection system. Further, vast amount of such threat parameter data is readily available allowing the possibility of performing a more complicated and detailed risk analyses, but on the other hand making it more difficult to quickly sort through the data.

There is a need for systems and methods which address these and other known problems in detecting, evaluating and assessing threat risks to timely intimate the organizations and protecting the facility from, attacks and other injuries.

Accordingly, it is desirable to provide a system and a method that is capable of accurately assessing, determining and visualizing risks that were previously undetectable by collecting and aggregating blended information from in-facility factors, out-facility factors and their consequences to determine potential risks including threats/hazards so that users can be better prepared when they turn into actual events. Moreover, such a system needs to be flexible so that it can be utilized with the existing infrastructure without requiring any changes therewithin.

### SUMMARY

An object of the invention is to dynamically identify any potential risks present within a facility, that may be caused due to in-facility factors as well as out-facility factors, in real time.

Yet another object of the invention is to visualize and generate alerts in real time basis on the detected risks.

It is yet another object of the invention to provide a kind of risk identification and visualization system configured on a user's computing unit.

It is yet another object of the present invention to provide a risk identification system that can be assembled in combination with existing infrastructure of a facility.

Yet another object of the present invention is to monitor risks associated to a facility and generate alarms/tickets to take an action to avoid turning them into actual events.

In an embodiment, a system for dynamically identifying risks related to a facility is disclosed. The system comprises a computing unit having a processor and memory configured to execute one or more programming instructions embodied thereon.

The computing unit includes a data receiving component adapted to receive risk one or more datasets from one or more data sources. The received datasets pertains to at least one risk associated to said facility. Particularly, the data-sources includes at least one in-facility data source comprising data-sets related to events occurring within the facility, and an out-facility data source comprising data-sets related to events occurring out of the facility but having an impact on the operations taking place within the facility. The computing unit further includes a risk scoring module adapted to assess the at least one risk associated to said facility. Particularly, the risk scoring module is configured to process the programming instructions embodied onto the memory to determine threats and/or risks scores related to the facility using the received datasets. The system further includes a visualization generation component that dynamically generates an interactive visualization of the risks and/or threats on to an output screen.

In an embodiment, a method for dynamically identifying and visualizing risks related to a facility is disclosed. The method comprises receiving risk related data sets from one or more data-sources using a data receiving component, processing collected data from the data-sources by implementing the programming instructions to determine various risk scores related to the facility, visualizing the risk scores onto a data visualization component and in turn optionally automatically generate an alarm and/or remedial tickets to one or more agencies based on risk visualized.

In an embodiment, a system for dynamically identifying risks related to a facility is provided. The system comprises a computing unit comprising a processor and a memory configured to execute one or more programming instructions embodied thereon; a data receiving component adapted to receive datasets from one or more data sources, the received data pertaining to at least one risk associated to said facility, the one or more data sources comprising at least one in-facility data source and at least one out-facility data source; a risk scoring module adapted to assess the at least one risk associated to said facility, the risk scoring module configured to process the programming instructions to determine threats and/or risks scores related to the facility using the received datasets; and a visualization generation component configured to generate an interactive visualization of the risks and/or threats on to an output screen.

In an embodiment, the programming instruction is further configured to perform a data correlation to draw a relation between the received datasets from the one or more data sources.

In an embodiment, the system further comprises a data sharing component that exposes data and visualizations used with-in the system to other external systems via an application programming interface (API).

In an embodiment, the computing unit comprises a mobile, touch-based computing hardware selected from but not limited to a smart phone, a tablet, and the like.

In an embodiment, the in-facility data source comprises data from one or more components present internally within the facility, such as including but not limited to sources such as access control systems, CCTV cameras, various sensors installed across the facility energy, power based systems, various employee management or other financial ERP installed within the facility, physical security incidents, system generated physical security alarms, facility systems alarms, security and safety incidents in facilities, data resiliency and information security feeds through infosec alarming systems such as Firewall alerts as well as SIEMs, or cyber threats such as vulnerabilities picked up during a pen-test, or through alarms received by firewall/cyber security assurance systems or any manual entries.

In an embodiment, the in-facility data source includes data from one or more components present externally to the facility such as such as news feeds, weather feed, social media feed, manual data import, or any other source of information available and having an impact on the risk assessment of the facility.

In an embodiment, the risk scoring module comprises a plurality of sub-modules, each sub-module configured to cater to a different perspective related to the facility.

In an embodiment, the data receiving component comprises a central repository adapted to store data received by the data receiving component from various data-sources.

In an embodiment, the visualization generation component comprises a user interface graphically depicting the one or more risks and/or threats onto an interactive dashboard.

In an embodiment, the user interface comprises an option allowing a user to prioritize one or more risk in accordance with business sensitivities and/or location sensitivities.

In an embodiment, the programming instructions are further configured to automatically categorize risks into different categories in accordance with the severity thereof.

In an embodiment, the set of programming instructions is further configured to automatically generate remedial tickets for the purpose of mitigation thereof.

In an embodiment, a method for dynamically identifying risks related to a facility is provided. The method comprises the steps of receiving datasets pertaining to risk within the facility from one or more data sources, the datasets comprising at least one in-facility dataset and at least one out-facility dataset; communicating the collected datasets to a processor of a computing unit; computing the risk scores of the facility by processing programming instructions stored at the processor of the computing unit; and visualizing the risk scores on a data visualization component.

In an embodiment, said processor is further configured to correlate the datasets received from different data-sources.

Numerous additional features, embodiments, and benefits of the methods and apparatus of the present invention are discussed below in the detailed description which follows.

### BRIEF DESCRIPTION OF ACCOMPANYING DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

FIG. 1 illustrates a block diagram of a risk identification system in accordance with one embodiment of the present subject matter.

FIG. 2 illustrates a flow chart depicting a method of identifying risks and visualizing them according to an embodiment of the present invention.

FIG. 3 illustrates an exemplary computing unit in accordance with one embodiment of the present invention.

FIGS. 4a through 4f illustrate an exemplary client application in accordance with one embodiment of the present invention.

### DETAILED DESCRIPTION

The following presents a detailed description of various embodiments of the present subject matter with reference to the accompanying drawings.

The embodiments of the present subject matter are described in detail with reference to the accompanying drawings. However, the present subject matter is not limited to these embodiments which are only provided to explain more clearly the present subject matter to a person skilled in the art of the present disclosure. In the accompanying drawings, like reference numerals are used to indicate like components.

The specification may refer to “an”, “one”, “different” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “attached” or “connected” or “coupled” or “mounted” to another element, it can be directly attached or connected or coupled to the other element or intervening elements may be present. As used herein, the term “and/or” includes any and all combinations and arrangements of one or more of the associated listed items.

The figures depict a simplified structure only showing some elements and functional entities, all being logical units whose implementation may differ from what is shown.

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented, and the needs of a particular application may yield multiple alternate and suitable approaches to implement the functionality of any detail described herein. Therefore, any approach may extend beyond the particular implementation choices in the following embodiments described and shown.

The present application discloses a risk identification and visualization system for determining presence of various risks, including potential threats and/or hazards that may be present and/or occur within a subject facility and thereafter, visualizing such risks in accordance to different categories on a data visualization component preferably in form of an interactive dashboard. The system is further adapted to auto generate various alarms and/or remedial tickets such that they can be taken up for correction within the facility. The system is generally provided in the form of a graphically visualized client application that could be accessed with a computer device, preferably in the form of a mobile application on an appropriate mobile device. However, in another embodiments, the system may be in form of a web-based automated service accessible on a generally known computing unit.

Particularly, the system of the current disclosure is adapted to identify risks associated to the subject facility while considering all the possible in-facility factors in combination with out-facility factors, such as including but not limited to general news, weather information, current affairs, natural calamities, social media, geographic updates, and the like, that may remotely be utilized for the purpose of determining any underlying threats and/or hazards within the facility. It is to be understood that unless otherwise indicated, this invention need not be limited to applications for industrial facility. As one of ordinary skill in the art would appreciate, variations of the invention may be applied to other possible risk identification operations such as in field of life coaching, medical treatments, including any other field of daily life where risk identification is required. Moreover, it should be understood that embodiments of the present invention may be applied in combination with various other management systems such as facility management systems, access management systems, human resource management system, occupational management systems, clinical systems, and the like, for various other possible applications. It must also be noted that, as used in this specification and the appended claims, the singular forms “a,” “an” and “the” include plural referents unless the context clearly dictates otherwise. Thus, for example, the term “a data-set” is intended to mean a single data-set or a combination of data-sets, “an algorithm” is intended to mean one or more algorithm for a same purpose, or a combination of algorithms for performing different program executions.

References to “one embodiment,” “an embodiment,” “at least one embodiment,” “one example,” “an example,” “for example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

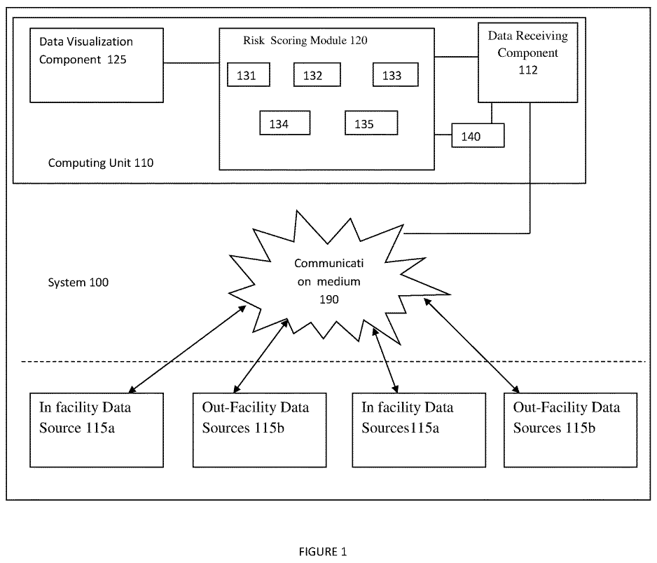

FIG. 1 is a system block diagram of a risk identification and visualization system according to the present invention. The system 100 includes a computing unit 110 having one or more data-receiving component 112 adapted to receive datasets 114 from a plurality of data-sources 115. The plurality of data sources 115 includes a plurality of datasets pertaining to factors relevant to determine any possible risk including threats and/or hazards related to a facility (not shown). Particularly, the plurality of data sources 115 include one or more in-facility data sources 115a storing data related to one or more components present within the facility and out-facility data sources 115b storing data related to one or more factors that may pertain even remotely to occurrence of a threat/hazard within the facility.

The system 100 further includes a risk scoring module 120 adapted to assess the at least one risk associated to said facility. Particularly, the risk scoring module configured 120 processes the received data sets 114 in accordance with one or more programming instructions 150 so to determine a risks score related to the facility using the received datasets 114. In an embodiment of the present invention, risk scoring module may compute and calculate risk scores based on the data-sets 114 processed in accordance to programming instructions 150 so as to calculate, identify, assess, rank, and determine a quantitative or qualitative value or level of risk based on known, anticipatory, historical, and/or premonitory data related to location(s) of, for example, the personnel, processes, and the equipment of the facility.

In certain embodiments, the programming instructions 150 may be based on any predetermined risk assessment model selected from a statistical models (e.g., linear regression, non-linear regression, Monte Carlo simulation, Markov models), physics-based models (e.g., LCF models, CFD models, FEA models, solid models, 3-dimension to 2-dimension FEA mapping models that may be used to predict the risk of equipment operation, undesired stoppages, or the need for equipment maintenance), heuristic models (e.g., neural networks, fuzzy logic models, expert system models, state vector machine models useful in risk and safety prediction), and so on, may be used to derive the risk based on the data-sets 114.

In some embodiments, the risk scoring module 120 may also calculate risks associated with locations of weather disruptions (and/or natural disasters such as earthquakes, tsunamis, hurricanes, tornadoes, and the like), which may be included as a singular risk factor or as an additional layer of risk in combination with the aforementioned. As will be further appreciated, calculated risk may be scored and assigned a certain risk level that may correspond to a number of control actions used to manage and mitigate such risk.

The system 100 furthermore includes a visualization generation component 125 to generate an interactive visualization of the risks in accordance with the risk score generated by the risk scoring module 120.

In some embodiments, the system 100 additionally includes a data correlation module 140 adapted to perform a data a correlation between the received datasets 114 from the one or more data sources 115.

In an embodiment, the risk scoring module 120 includes a plurality of sub modules 130, each associated to a predetermined perspective of the facility. For example, in some embodiments, the sub module 130 includes an alarms module 131, an incident module 132, a response module 133, a health module 134, and an overall system risk module 135. Each of the sub-module 130 is associated to a predetermined programming instruction set, embodied onto the memory and adapted to generate a score specific to the predetermined perspective thereof. For example, the alarm module 131 provides information and scores related to various alarms positioned within the facility. The incident module 132 is associated to another set of programming instruction and is adapted to generate a score related to various incidents taking place within the facility. The response module 133 is associated to yet another set of programming instructions 150 and is adapted to generate a score related to various responses being performed within the system. Similarly, the health module 134 using yet another set of programming instructions 150, is adapted to determine health status of different stations of the facility. Furthermore, the overall risk module 135 is adapted to consider all the other sub-modules 130 and using yet another set of programming instructions 150 to calculate an overall risk score within the facility. The risk scores of each of the sub-module 130 is specifically utilized by a wide variety of user groups (such as Security group, facilities management, administration and logistics as well as finance) to know their risk outlook and make well informed decisions.

Example of in-facility data set includes regulatory data, security data, utilities data, industrial data, logic controller data, compliance data, corporate IT data, and other types of data from within the facility but is not limited to data feed through a plurality of online and/or offline sources such as access control systems, CCTV cameras, various sensors installed across the facility energy, power based systems, various employee management or other financial ERP installed within the facility, Physical security incidents, system generated physical security alarms, facility systems alarms, security and safety incidents in facilities, data resiliency and information security feeds through infosec alarming systems such as Firewall alerts as well as SIEMs, or cyber threats such as vulnerabilities picked up during a pen-test, or through alarms received by firewall/cyber security assurance systems or any manual entries related to Energy Management IOT, HVAC, physical and cyber protection of Sensitive Assets & Intellectual Property sensitive asset diversion (dangerous chemicals, pathogens, nuclear material), Cyber Attacks—Utilities (Water, Power, Gas), Smart Grids, Transportation etc.

Example of out-facility data set includes but is not limited to data feed through a plurality of online and/or offline sources such as news feeds and/or social media feed available on information such as on public protests, theft, altercation, intrusion, medical, terrorism (e.g. chemicals stolen to make explosives) bio terrorism (e.g. food & beverage, consumer products), sabotage, pandemic, drills, accident, etc. The out-facility data-set may further include information from weather related feeds such as on storm, snow/fog, heavy rain, earthquake, etc., In other embodiment, the out-facility data-set further includes information received through manual data import, or any other source of information available and having an impact on the risk assessment of the facility.

The system 100 and/or the computing unit 110 is intended to represent various forms of mobile devices, such as personal digital assistants, cellular telephones, smart phones, and other similar computing units along with other disclosed sensors. The components shown here, their connections and relationships, and their functions, are meant to be exemplary only, and are not meant to limit implementations described and/or claimed in this document.

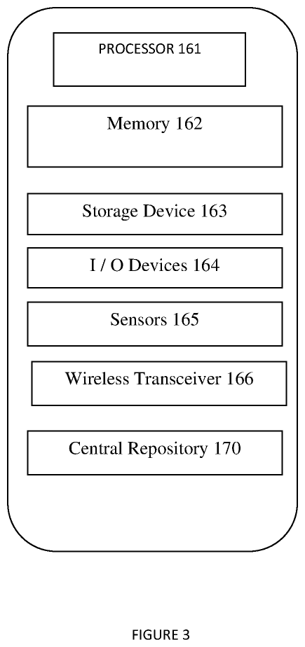

In a preferred embodiment, as illustrated in FIG. 3, the computing unit 110 includes a processor 161, memory 162, a storage device 163, a high-speed interface connecting to memory and high-speed expansion ports, and a low speed interface connecting to low speed bus, one or more input/output (I/O) devices 164 and a plurality of sensors 165. Each of the components 161, 162, 163, 164, 165 are interconnected using various busses, and may be mounted on a common motherboard or in other manners as appropriate. The processor 161 can process the programming instructions 150 for execution within the system 100. In a preferred embodiment, the programming instructions 150 may be stored in the memory 162 or on the storage device 163 to display graphical information for a GUI on an external input/output device 164, such as display coupled to high speed interface. In other implementations, multiple processors and/or multiple busses may be used, as appropriate, along with multiple memories and types of memory.

In an embodiment of the present invention, the data receiving component 112 is connected with one or more of plurality of data sources 115 through a communication medium 190 such as a wireless communication connection, so as to receive data-sets 114 information through a wireless transceiver module 166. However, in other embodiments, the data receiving component 112 may use the input/output device 164 to receive datasets 114 input by a user group handling the system 100. In yet other embodiments, the data receiving component 112 may additionally use the plurality of sensors 165 to receive various information from other sensors positioned across the facility to collect each and any relevant datasets 114 throughout the facility. In yet another embodiment of the present invention, the data receiving component 112 may use a camera device to collect the datasets in the form of real time images and/or video. In yet other embodiment, the data receiving component 112 may include various application programming interface (API) connected to the data sources 115 so as to receive data-sets 114 there from in a format acceptable by the source API and readable by the computing unit 110.

The data receiving component 112 is connected with a central processor 161 so as to send the collected datasets 114 to the central processing unit in real time.

The risk visualization generation component 125 is adapted to receive risk scores from the risk identification modules and/or sub modules to provide visualizations for a multidimensional data-sets as received by the data receiving component 112 and the risk scores, and/or tickets as generated within the system 100. In a preferred embodiment, the data visualization component 125 displays graphical representations or visualizations of risk scores categorized among multiple dimensions such as geographical areas, incident categories, health status, access management systems, and various possible metrics such as for example, financial, physical, IT based, for example. The visualization may further include predetermined as well as dynamically updateable filters on the data, such as risk-scores, dimension, and categorical filters, may require a user to go into a separate data view to select data sets of interest.

Further, in some exemplary embodiments, the interactive risk visualizations enables users to easily swipe, pinch, zoom-in or zoom-out, drag-and-drop, rotate, or perform other operations to gain a better understanding of the risks that may be presented by the component. Further, the datasets from the in-facility as well as out-facility source may be correlated with the risk scores to provide a combined and/or organized analysis of unwanted situations. In some embodiments, the visualization may include a time-based slider that may enable users to seamlessly switch between live and historical streams that can come from various sources (e.g., real-time store, temporary data cache, historical data store, etc.). Further, the real-time risks may be compared with a historical baseline based on simultaneously streaming from a real-time store, a temporary data cache, or a historical data store. It is understood that various features (e.g., components, operations, or other features) described herein may be implemented separately or in combination with other features.

In an embodiment of the present invention, the processor 161 simultaneously compares the risk score generated for each of the sub-modules 130 and if one or more of the risk score values exceeds a threshold value, then an remedial unit automatic generates a remedial ticket for the management to take a remedial action on the basis of the same. In yet another embodiment, the risk score if well beyond the acceptable threshold value, the system may generate a visual/sound alarm so that the user managing the application may take over a quick action onto the same.

The processor 161 may communicate with a user through control interface [not shown] and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to a user. The control interface may receive commands from a user and convert them for submission to the processor 161. In addition, an external interface may be provided in communication with processor 161, so as to enable near area communication of system 100 with other devices. External interface may provide, for example, for wired communication in some implementations, or for wireless communication in other implementations, and multiple interfaces may also be used.

The computing unit 110 is shown as including the memory 162. The memory 162 may store the executable programming instructions 150. The executable instructions 150 may be stored or organized in any manner and at any level of abstraction, such as in connection with one or more applications, processes, routines, procedures, methods, functions, etc.

In one implementation, the memory 162 is a volatile memory unit or units. In another implementation, the memory 162 is a non-volatile memory unit or units. The memory 162 may also be another form of computer-readable medium, such as a magnetic or optical disk. In one implementation, a computer program product is tangibly embodied in an information carrier. The computer program product contains instructions that, when executed, perform one or more methods, such as those described above. The information carrier is a computer- or machine-readable medium, such as the memory, expansion memory, or memory on processor.

Expansion memory may also be provided and connected to the computing unit 110 through the expansion interface, which may include, for example, a SIMM (Single In-Line Memory Module) card interface. Such expansion memory may provide extra storage space for the computing unit 110 or may also store applications or other information for the computing unit 110. Specifically, expansion memory may include instructions to carry out or supplement the processes described above and may include secure information also. Thus, for example, expansion memory may be provided as a security module for computing unit 110 and may be programmed with instructions that permit secure use of computing unit 110. In addition, secure applications may be provided via the SIMM cards, along with additional information, such as placing identifying information on the SIMM card in a non-hackable manner.

The instructions stored in the memory 162 may be executed by one or more processors, such as a processor 161. The processor 161 may be coupled to one or more input/output (I/O) devices 165.

The storage device 166 is capable of providing mass storage for the computing unit 110. In one implementation, the storage device 166 may be or contain a computer-readable medium, such as a floppy disk device, a hard disk device, an optical disk device, a tape device, a flash memory or other similar solid state memory device, or an array of devices, including devices in a storage area network or other configurations.

A computer program product can be tangibly embodied in an information carrier. The computer program product may also contain instructions that, when executed, perform one or more methods, such as those described above. The information carrier is a computer- or machine-readable medium, such as the memory 162, the storage device 166, or memory on processor 161.

In some embodiments, the I/O device(s) 165 may include one or more of a keyboard or keypad, a touchscreen or touch panel, a display screen, a microphone, a speaker, a mouse, a button, a remote control, a joystick, a printer, a telephone or mobile device (e.g., a smartphone), a sensor, etc. The I/O device(s) 165 may be configured to provide an interface to allow a user to interact with the computing unit 110 and/or the system 100.

The memory 162 may include a central repository 170 for storing data pertaining to various risks associated to the facility and received by the data-receiving component 112. The datasets 114 may include data provided by one or more sensors 165, or from one or more of the plurality of data sources 115. The central repository 170 may further store details on all systems alarms and how the alarms were attended to. The central repository 170 furthermore store details on complete incident and event log that clearly shows incident types, incident types, actions taken when incidents happen—all in a nice visualized format.

The computing unit 110 may communicate wirelessly through communication interface, which may include digital signal processing circuitry where necessary. Communication interface may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a Bluetooth, Wi-Fi, or other such transceiver (not shown). In addition, GPS (Global Positioning System) receiver module may provide additional navigation- and location-related wireless data to system 100, which may be used as appropriate by applications running on the computing unit 110.

The computing unit 110 may also communicate audibly using audio codec, which may receive spoken information from a user and convert it to usable digital data set 114. Audio codec may likewise generate audible sound for a user, such as through a speaker, e.g., in a handset of the computing unit 100. Such sound may include sound from voice telephone calls, may include recorded sound (e.g., voice messages, music files, etc.) and may also include sound generated by applications operating on the computing unit 110.

Additionally, the computing unit 110 may include Universal Serial Bus (USB) flash drives. The USB flash drives may store operating systems and other applications. The USB flash drives can include input/output components, such as a wireless transmitter or USB connector that may be inserted into a USB port of another computing unit.

The system 100 is illustrative. In some embodiments, one or more of the entities may be optional. In some embodiments, additional entities not shown may be included. For example, in some embodiments the system 100 may be associated with one or more networks. In some embodiments, the entities may be arranged or organized in a manner different from what is shown in FIG. 1.

Preferably, the computing unit 110 maybe a signal-connected with a GPS module for collecting a geographical location at a monitoring point, and the GPS module sends a geographical location signal to a processor; and the processor sends the geographical location signal to the master processor The wireless transceiver module further sends the received geographic location signal to the data receiving component 112.

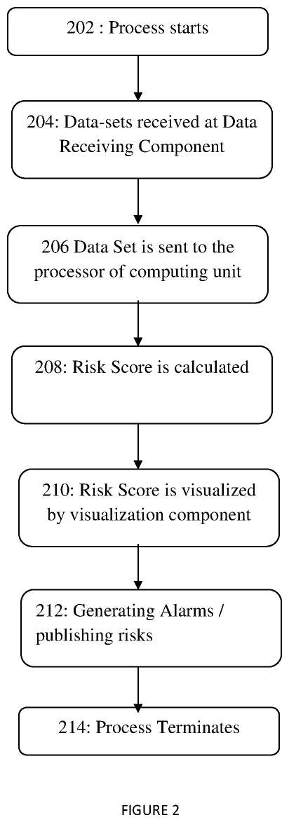

FIG. 2 illustrates a flow chart of a method of dynamically identifying risks including the potential threats and/or hazards, related to a facility and a visualization system according to the present invention. The method starts at step 202 and proceeds to step 204.

At step 204, one or more data sets 114 pertaining to risk within the facility, are received at the data receiving component 112 of the computing unit 110 from one or more data sources 115 such as various security and other facility systems running in the ecosystem, and also from external feeds from open source sites through RSS/XML feeds for weather, news, social feeds etc., in addition to manual data entries of incidents.

The data sets 114 includes at least one in-facility dataset and at least one out-facility dataset. Further, the datasets 114 is converted into in a readable format as may be accepted by the system 100. Further, the data sets 114 may be assimilated using various filters to standardize the database. Furthermore, the data set 114 received is stored within a central repository 170 and/or the memory 162 present within the computing unit 110.

At step 206, the collated data sets 114 is sent to the central processor 161 for the purpose of processing thereat using one or more risk detection modules 120 and/or sub-modules 130.

At step 208, the receive data sets is processed in accordance with the programming instructions 150 stored within the computing unit 110 to determine various risk scores in accordance with different risk modules 120 and/or 130.

At step 210, the generated risk score is visualized by a visualization component 125 to display risks scores related to each of the sub-modules 130 onto one or more dashboards, to present risks are identified as per business nature, geographic location and any specific risks identified by the system 100 in accordance to predetermined programming instructions 150. In an embodiment, the processor may utilize one or more computer languages and algorithms to compute the risk scores and completing a visualization thereof.

Lastly, at step 212, the system 100 may be published over a variety of operating environments—web, smartphone and tablet devices. Further, the system 100 generate visual/sound notification to the user of system 100 which may be triggered based on detecting that the pre-determined levels of the risk scores have been crossed and now the facility may be in a an extremely high risk zone. Additionally, in some embodiments, the system 100 may also send reporting emails to one or more addresses as specified within a control interface of the system 100. Moreover, the risk scores including various datasets etc. are automatically archived within the central repository 170 of the system 100.

The process terminates at step 214.

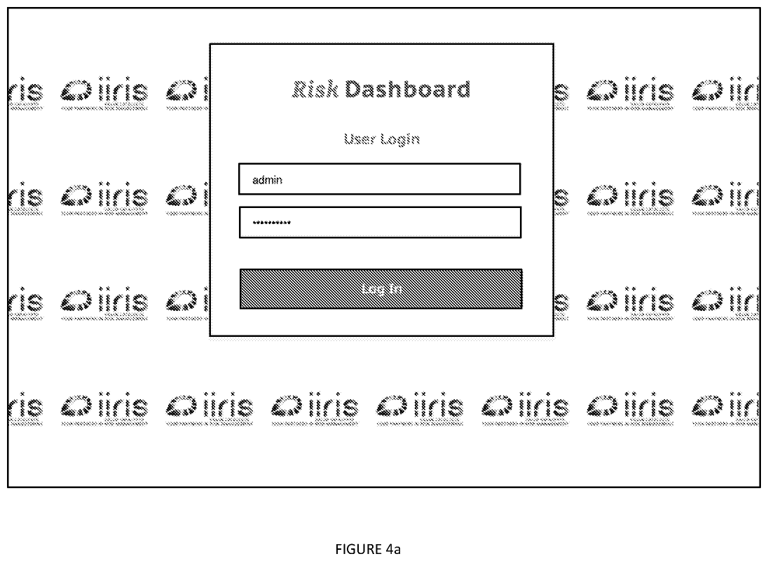

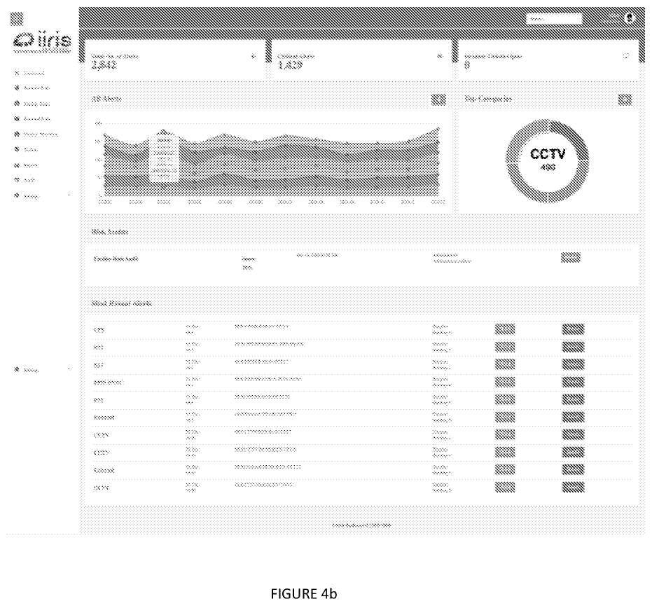

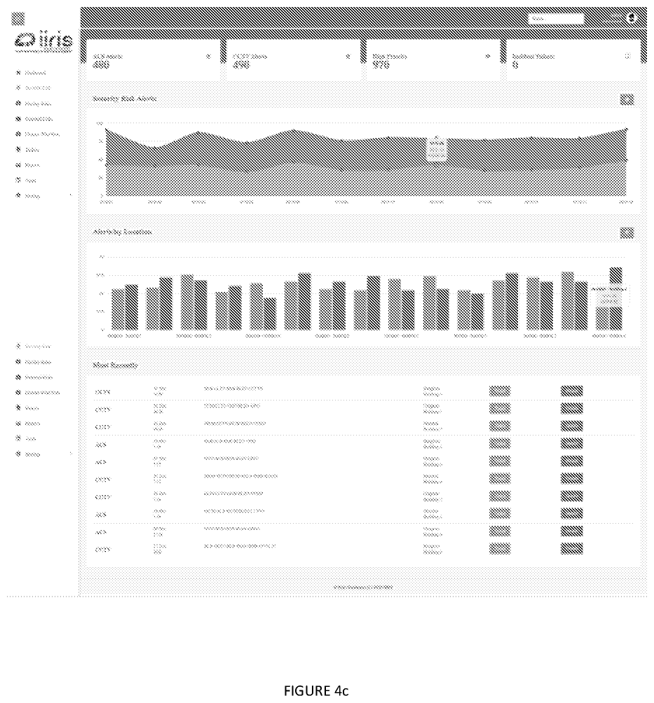

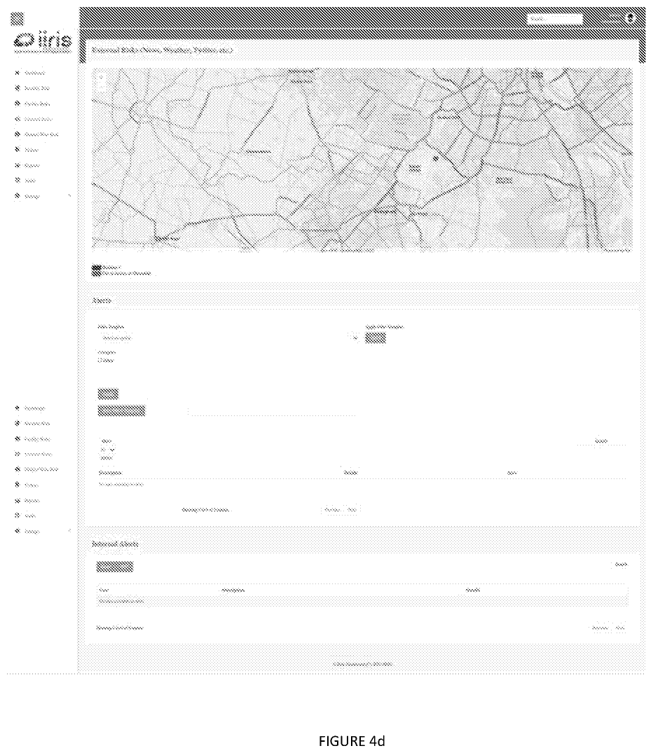

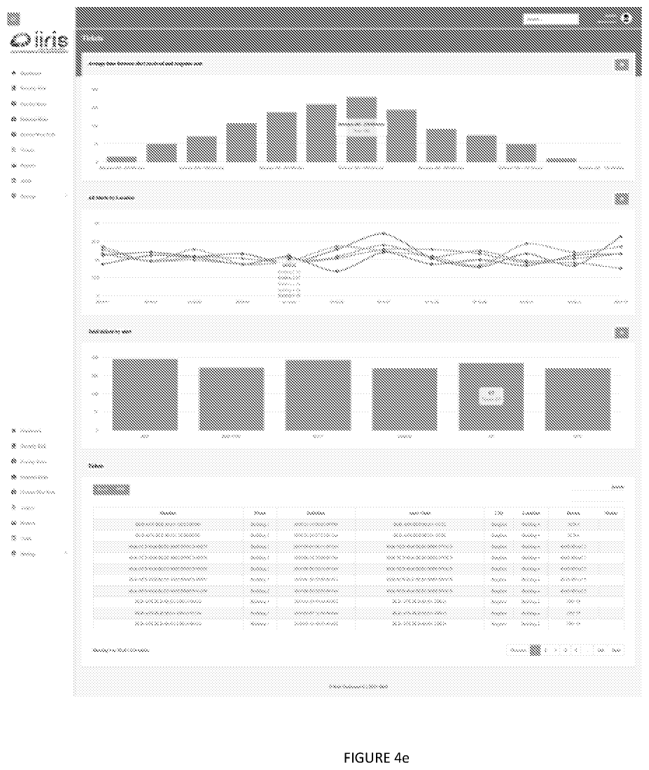

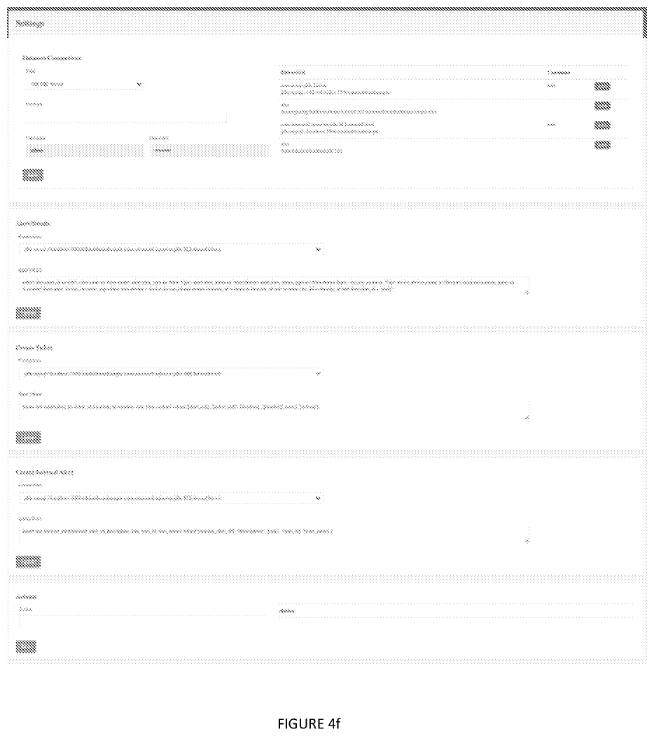

FIG. 4 illustrates an exemplary embodiment. According to an embodiment, the system 100 is exemplified with a client architecture system in the form a mobile application 400 as illustrated. The mobile application 400 includes a It comprises of a front-end user interface that can run off a standard web-browser on desktop environments, or a mobile based smartphone or tablet versions (for Android and iOS); and a backend server which can be a light weight workstation machine that will collect and process the data-sets received from one or more data sources. In an embodiment, as illustrated, the front end user interface includes a login page. The logins for users are created and right management of the users are provisioned at the time of installation of the system 100 to enable security of the datasets, reports, risks visualization generated on the user interface of the mobile application 400. In some embodiments, one or more users' roles may be provisioned by system administrator managing the system 100.

When the user logins, the user is presented with a main landing page as illustrated in FIG. 4b displaying a highlight of the critical alarms, total number of alerts, alert categories, incident tickets etc. The alerts are raised when the risk scoring module assesses the risk associated with the facility. The risk scoring module determine threats and/or hazards related to the facility using the datasets received from different databases. The system envisages the overall risk based on certain business logics, extent of the physical risk, historical impacts that the business has seen as well as possible impacts that the business may see in due course. The module also assesses the supplemental data such as results of internal risk audits, a rundown of latest alerts, curated category and location wise etc. Each of such information is displayed onto a dedicated landing page.

The mobile application displays different dashboards based on the type of the risk alerts such as security risk alert, facility risk alerts, external risk alerts, district-wise risk etc. The security risk alerts dashboard represents all security related alarms and incident tickets that are currently open. These alarms can be categorized based on priority, and alarm type (CCTV, Access Control or Manual Feed). The data on the dashboard is presented as per total alarm volume over a period of time.

Further, the second dashboard as illustrated in FIG. 4c, shows the type of alarms generated for all facility. The dashboard further includes the incident tickets that are currently open. Another dashboard i.e. an external risk alert includes all external alarms picked up from open source media sites, news sites, weather feeds and manual inputs etc. The alarms therein can be categorized based on priority, and incident type, and the data is visualized on a GIS map.

Another dashboard is district-wise risk alert as illustrated in FIG. 4d that visualizes the risk applicable to various states and districts of the country, and highlights risk as per color codes—into high, medium and low risk categories.

Besides the above dashboards, the system includes a display for the open tickets over a period of time as illustrated in FIG. 4e. The visualization component generates the average time between alerts received and response sent, alerts by locations and total tickets by alert type (ACS, CCTV, IOT, External, IOT, Internal). Once the visualization component generates the alert, the user will be able to generate the ticket as per category and publish it into the ticket case manager. All user generated tickets are populated on this dashboard as per unique number, location, data and time stamp, alert code, city, device identifier or alarm category, location and user name in case of a manual input.

Further, the system allows for self-auditing of security arrangements and facility management arrangements across a variety of disciplines for a particular site. The audit schematics will be configured and populated as per client's security and facility management and the system will provide an overall security and facility risk posture score for that facility—which will be highlighted in the landing page.

In order to receive the risk alerts, the user defined data sets are provisioned for security and facility feeds at a control setting feature as illustrated in FIG. 4f.

Generally, the data is directly fed into the system through an automated hookup or through manual entries via the System Data Settings. Further, the system is able to accept the external feed through the manual inputs, which are provided by an operator on the ground, or through automated sources. The system can also receive the data from third party resources such as weather, news and social media etc. Once the data sets are received from disparate sources, the data is collated and assessed to find out the risk scoring, and the alerts are visualized on the dashboards.

Henceforth, the system 100 of current disclosure provides capability for analyzing risk across all possible domains that may have an impact on a facility such as an industrial facility but not limited thereto. Such a system also provides a capability of detecting, identifying and eliminate the risks even before they manifest and therefore further allows a possibility of any unwanted events to take place due to any possible factor happening within or out of the facility. Further, a light weight yet sophisticated dashboard is provided to visualize possible security and safety risk across various physical assets (buildings and facilities owned by the organization) across the geographies of the facility. The data may be feed through a plurality of sources such as access control systems, CCTV cameras, various sensors installed across the facility energy, power based systems, various employee management or other financial ERP installed within the facility, Physical security incidents, system generated physical security alarms, facility systems alarms, security and safety incidents in facilities, data resiliency and information security feeds through infosec alarming systems such as Firewall alerts as well as SIEMs, or cyber threats such as vulnerabilities picked up during a pen-test, or through alarms received by firewall/cyber security assurance systems or any manual entries. The data may also be feed through external sources such as news feeds, weather feed, social media feed, manual data import, or any other source of information available and having an impact on the risk assessment of the facility. Further, the system of current disclosures enables a visual feedback of the over-all risk that the system envisages based on certain business logics, extent of the physical risk envisaged during various risk assessment exercises, historical impacts that the business has seen as well as possible impacts that the business can see in due course.

It is noted that various connections are set forth between elements in the description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Various embodiments of the invention have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements for e.g.: pre-determined level of one or more parameters of gases as declared by government. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C,” “C++,” “Visual C++,” Java, and “Visual Basic.” Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The claims can encompass embodiments for hardware, software, or a combination thereof.

Although a few implementations have been described in detail above, other modifications are possible. Moreover, other mechanisms for performing the systems and methods described in this document may be used. In addition, the logic flows depicted in the figures may not require the particular order shown, or sequential order, to achieve desirable results. Other steps may be provided, or steps may be eliminated, from the described flows, and other components may be added to, or removed from, the described systems. Accordingly, other implementations are within the scope of the following claims.

While the preferred embodiments of the present invention have been described hereinabove, it should be understood that various changes, adaptations, and modifications may be made therein without departing from the spirit of the invention and the scope of the appended claims. It will be obvious to a person skilled in the art that the present invention may be embodied in other specific forms without departing from its spirit or essential characteristics. The described embodiments are to be considered in all respects only as illustrative and not restrictive.

1. A system for dynamically identifying risks related to a facility, the system comprising:
a computing unit comprising a processor and a memory configured to execute one or more programming instructions embodied thereon;
a data receiving component adapted to receive datasets from one or more online and/or offline data sources, the received data pertaining to at least one risk associated to said facility, the one or more data sources comprising at least one in-facility data source and at least one cut-facility data source;
a risk scoring module adapted to assess the at least one risk associated to said facility, the risk scoring module configured to process the programming instructions to determine threats and/or risks scores related to the facility using the received datasets; and
a visualization generation component configured to generate an interactive visualization of the risks and/or threats on to an output screen.

2. The system as claimed in claim 1, wherein the programming instruction is further configured to perform a data correlation to draw a relation between the received datasets from the one or more data sources.

3. The system as claimed in claim 1 further comprising a data sharing component that exposes data and visualizations used with-in the system to other external systems via an application programming interface (API).

4. The system as claimed in claim 1, wherein the computing unit comprises a mobile, touch-based computing hardware selected from but not limited to a smart phone, a tablet, and the like.

5. The system as claimed in claim 1, wherein the in-facility data source comprises various online and/or offline data sources receiving data from one or more components present internally within the facility, such as including but not limited to sources such as access control systems, CCTV cameras, various sensors installed across the facility energy, power based systems, various employee management or other financial ERP installed within the facility, physical security incidents, system generated physical security alarms, facility systems alarms, security and safety incidents in facilities, data resiliency and information security feeds through infosec alarming systems such as Firewall alerts as well as SIEMs, or cyber threats such as vulnerabilities picked up during a pen-test, or through alarms received by firewall cyber security assurance systems or any manual entries

6. The system as claimed in claim 1, where in the out-facility data source comprises various online and/or offline data sources receiving data from one or more components present externally to the facility such as such as news feeds, weather feed, social media feed, manual data import, or any other source of information available and having an impact on the risk assessment of the facility.

7. The system as claimed in claim 1, wherein the risk scoring module comprises a plurality of sub-modules, each sub-module configured to cater to a different perspective related to the facility.

8. The system as claimed in claim 1, wherein the data receiving component comprises a central repository adapted to store data received by the data receiving component from various data-sources.

9. The system as claimed in claim 1, wherein the visualization generation component comprises a user interface graphically depicting the one or more risks and/or threats onto an interactive dashboard.

10. The system as claimed in claim 1, wherein the user interface comprises an option allowing a user to prioritize one or more risk in accordance with business sensitivities and/or location sensitivities.

11. The system as claimed in claim 1, wherein the programming instructions are further configured to automatically categorize risks into different categories in accordance with the severity thereof.

12. The system as claimed in claim 1, wherein the set of programming instructions is further configured to automatically generate remedial tickets for the purpose of mitigation thereof.

13. A method for dynamically identifying risks related to a facility, said method comprising:
receiving datasets pertaining to risk within the facility from one or more data sources, the datasets comprising at least one in-facility dataset and at least one out-facility dataset;
communicating the collected datasets to a processor of a computing unit;
computing the risk scores of the facility by processing programming instructions stored at the processor of the computing unit; and
visualizing the risk scores on a data visualization component.

14. The method for dynamically identifying risks as claimed in claim 13, wherein said processor is further configured to correlate the datasets received from different data-sources.
